(19) United States
(12) Patent Application Publication
(10) Pub. No.: US 2006/0044083 A1
(43) Pub. Date: Mar. 2, 2006

(54) Circuit board and method for producing a circuit board

(76) Inventor: Maksim Kuzmenka, Munich (DE)

Correspondence Address: SLATER & MATSIL LLP, 17950 PRESTON ROAD, SUITE 1000, DALLAS, TX, 75252, US

(21) Appl. No.: 10/928,605

(22) Filed: Aug. 27, 2004

(51) Int. Cl. H01P 3/08; H01P 5/02

(52) U.S. Cl. 333/246

(57) ABSTRACT

A circuit board comprises a dielectric layer with a through-hole between a first and a second surface of the dielectric layer. An electrically conductive coating is arranged on a wall of the through-hole between the first and the second surface and a first signal trace is arranged on the first surface and a second signal trace is arranged on the second surface of the dielectric layer. The wire passing through the through-hole connects the first signal trace to the second signal trace.

### BACKGROUND OF THE INVENTION

1. Field of the invention

The present invention relates to circuit boards and to a method of producing the same, and in particular to circuit boards comprising connections between signal traces of different layers.

2. Description of the Prior Art

Printed circuit boards usually comprise a plurality of layers for signal traces. For boards operating with signal frequencies of several GHz, printed circuit board traces are normally realized by way of strip lines or micro-strip lines. Printed circuit boards with a plurality of layers usually comprise a ground reference plane and a supply voltage reference plane which provide current return paths for signals of the signal layers. Each modern printed circuit board which comprises more than one signal layer usually contains a plurality of vias. A via is an interconnection for traces of different signal layers. A printed circuit board may contain tens or even thousands of vias.

FIG. 3a shows a cross-sectional view of a section of a printed circuit board with one via. The circuit board comprises a dielectric layer 301 with a through-hole 305. A first signal trace 307 is arranged on a first surface and a second signal trace 309 is arranged on a second surface of the dielectric layer 301, wherein the second surface is opposite to the first surface. The through-hole 305 comprises an electrically conducting coating which is connected to annular plates 317a, 317b on the two surfaces of the dielectric layer 301. The plates 317a, 317b are connected to the signal traces 307, 309. An electrically conducting connection between the first signal trace 307 and the second signal trace 309 is provided by the first plate 317a, the coating 317 and the second plate 317b.

A first supply plane 321 and a second supply plane 322 are arranged within the dielectric layer 301, in parallel to the signal traces 307, 309. The supply planes 321, 322 are not connected to the coating 317 of the through-hole 305. Further, the signal layer comprising the signal trace 307, the first supply plane 321, the second supply plane 322 and the signal layer comprising the second signal trace 309 are separated from each other by sub-layers of the dielectric 301, such that a four-layer board is realized. The through-hole 305 may be a drilled hole which is metal plated in order to realize the coating 317. The first supply plane 321 may be a power plane and the second supply plane 322 may be a ground plane VDD.

FIG. 3b shows a three-dimensional view of the conventional via as it is described in FIG. 3a. For reasons of clarity the dielectric layers, power planes and ground planes are not shown in FIG. 3b. As can be seen from FIG. 3b, the first and second signal traces 307, 309 are realized as strip lines and are connected to the plates 317a, 317b of the metal-plated coating 317 of the through-hole.

FIG. 3c shows an equivalent schematic of the typical printed circuit board via as it is shown in FIGS. 3a and 3b. A first impedance Z1 represents the first signal trace and a second impedance Z2 represents the second signal trace. An inductance L represents the coating 317, a first capacity C1 represents the first plate and a second capacity C2 represents the second plate of the via.

The main problem of existing via designs is the necessity of large plates 317a, 317b for a reliable contact between signal traces 307, 309 and the coating 317 of metal-plated hole 305. Normally, the dimension of the plates 317a, 317b is much larger than a width of the signal traces 307, 309 which results in a too high capacitance.

Printed circuit board signal traces 307, 309 typically have a normalized impedance Z1, Z2 of 60 Ohm. For vias used in printed circuit boards for modern DIMM memory modules (DIMM; DIMM=Duals In Line Memory Module) the inductance L usually has a value of 0.6 nH and the capacities C1, C2 have values of 0.3 pF. A characteristic impedance of the via shown in FIGS. 3a-c corresponds to the square root for L/C1, C2 and typically is 31.6 Ohm. Thus, there is a step in the impedance for the first trace to the via and from the via to the second via. Such an impedance step from 60 Ohm to 31 Ohm distorts a signal which propagates on the signal traces.

Normally a via as it is shown in FIGS. 3a-c works properly for frequencies up to several hundred MHz. Nevertheless, each discontinuity of the geometry of a signal trace leads to an impedance changing and as a consequence to unavoidable signal reflections and distortions. Therefore, at higher frequencies most design rules are limiting the number of vias per trace. In the GHz range, normally only one via is allowed per trace.

A further disadvantage of the via shown in FIGS. 3a-c is a break in the current return path of a signal propagating from the first signal trace to the second signal trace. Each signal trace normally has a good current return path on the reference ground plane or the reference supply plane. This current return path becomes broken when the signal jumps from the first signal trace of the top layer to the second signal trace of the bottom layer.

### SUMMARY OF THE INVENTION

It is the object of the present invention to provide a circuit board allowing high frequency signal transmissions and a method for producing such a circuit board.

In accordance with a first aspect, the present invention provides a circuit board comprising: a dielectric layer; a through-hole between a first and a second surface of the dielectric layer; an electrically conductive coating arranged on a wall of the through-hole between the first and the second surface; a first signal trace arranged on the first surface; a second signal trace arranged on the second surface; and a wire passing through the through-hole and connecting the first signal trace to the second signal trace, wherein the wire and the conductive coating form a coaxial line.

In accordance with a second aspect, the present invention provides a method for producing a circuit board comprising the steps of: providing a dielectric layer comprising a through-hole between a first and a second surface of the dielectric layer and a first signal trace being arranged on the first surface and a second signal trace being arranged on the second surface of the dielectric layer; arranging an electrically conductive coating on a wall of the through-hole between the first and the second surface; arranging a wire within the through-hole such that a dielectric is arranged between the wire and the conductive coating; and connecting the wire to the first signal trace and the second signal trace, wherein the wire and the conductive coating form a coaxial line.

The present invention is based on the finding that an impedance-controlled via can advantageously be achieved making use of a coaxial structure in order to prevent signal reflections and distortions.

In accordance with the invention, the through-hole comprises an electrically conducting coating and an electrically isolating element is arranged between the coating and the wire. The coating can be connected to a ground or supply plane. Therefore, a via according to the present invention is effective as a piece of coaxial cable. By properly calculating the diameter of the wire, the hole and the dielectric constant of the isolating element, the impedance of the via can be adapted to impedances of the signal traces of the circuit board even for high frequencies. This is an advantage especially for thick printed circuit boards.

A further advantage is that a signal partly keeps a current return path along the via if the coating of the through-hole is connected to the ground or supply plane. A plated hole which forms the coating can be made in the same technology cycle as normal vias. This is an advantage as no additional manufacturing step is necessary. Moreover, only a part of the vias of a circuit board, especially vias used for high frequency traces can be replaced by coaxial vias as proposed by the present invention. For the other vias the conventional type of a via can be used.

### BRIEF DESCRIPTION OF THE DRAWINGS

These and other objects and features of the present invention will become clear from the following description taken in conjunction with the accompanying drawings, in which:

FIG. 1a is a cross-sectional view of a circuit board according to an embodiment of the present invention;

FIG. 1b is a three-dimensional view of the circuit board shown in FIG. 1a;

FIG. 1c is an equivalent schematic of the circuit board shown in FIG. 1b;

FIG. 2a is a cross-sectional view of a wiring element according to an embodiment of the present invention;

FIG. 2b is a three-dimensional view of the wiring element shown in FIG. 2a;

FIG. 3a is a cross-sectional view of a circuit board according to the prior art;

FIG. 3b is a three-dimensional view of the circuit board shown in FIG. 3a; and

FIG. 3c is an equivalent schematic of the circuit board shown in FIG. 3b.

### DESCRIPTION OF THE PREFERRED EMBODIMENTS

In the following description of the preferred embodiments of the present invention same or similar reference signs are used for similar elements in the different drawings, wherein a repeated description of these elements is left out.

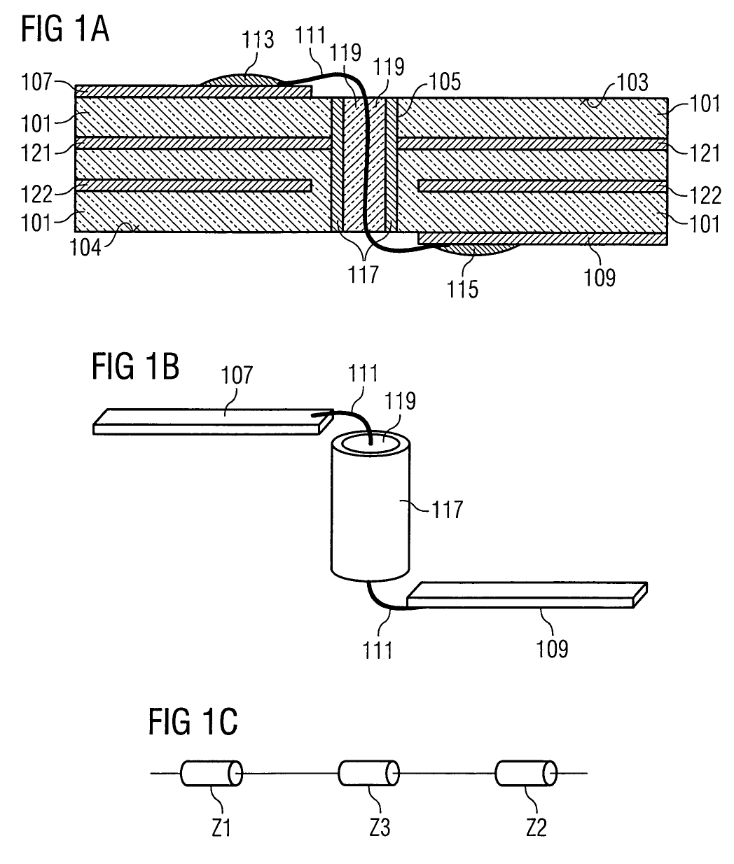

FIG. 1a shows a cross-sectional view of a circuit board according to an embodiment of the present invention. The circuit board comprises a dielectric layer 101 with a first surface 103 and a second surface 104, wherein the first surface 103 is opposite to the second surface 104. The dielectric layer 101 comprises a through-hole 105 between the first surface 103 and the second surface 104. A first signal trace 107 is arranged on the first surface 103 and a second signal trace 109 is arranged on the second surface 104. A wire 111 connects the first signal trace 107 via the through-hole 105 with the second signal trace 109. In this embodiment, the wire 111 is connected by solder bumps 113, 115 to the signal traces 107, 109.

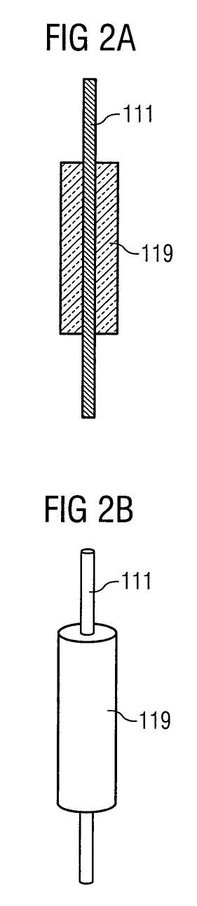

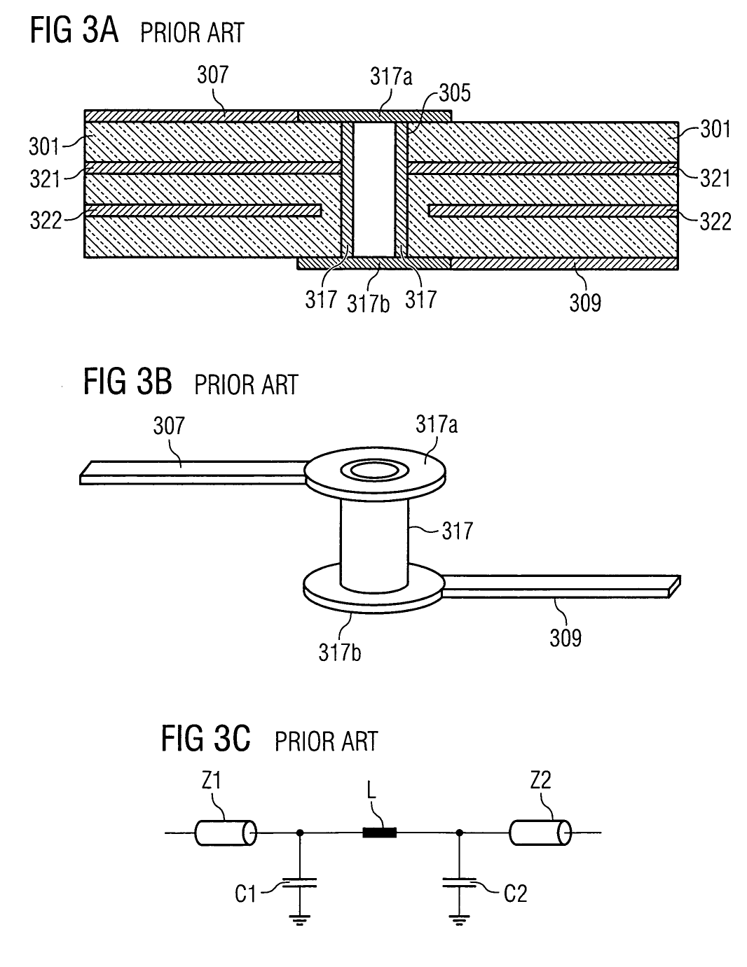

The wire 111 provides an electrical connection between the first signal trace 107 and the second signal trace 109. The signal traces 107, 109 are formed as strip lines or micro-strip lines on the surfaces 103, 104 of the dielectric layer 101. The through-hole 105 or drilled hole is metal plated, so that it comprises an electrically conducting coating 117. In order to isolate the wire 111 from the coating 117, an electrical isolating element 119 is arranged between the wire 111 and the coating 117. A detailed description of the isolating element 119 follows referring to FIGS. 2a, 2b.

As can be seen in FIG. 1a, the signal traces 107, 109 are spaced apart from the through-hole 105 in order to prevent an electrical connection between the signal traces 107, 109 and the coating 117.

In this embodiment, the circuit board comprises supply planes 121, 122. The first supply plane 121 is connected to the coating 117. The second supply plane 122 is isolated from the coating 117. The supply planes 121, 122 may be power planes or ground planes which are arranged within the dielectric layer 101 in parallel to the surfaces 103, 104 of the dielectric layer 101.

The first surface 103 provides a first signal layer and the second surface 104 provides a second signal layer. The first supply plane 121 is isolated from the first signal layer and from the second supply layer 122 by dielectric sub-layers. The second supply layer 122 is isolated by a dielectric sub-layer from the second signal layer. Thus, the dielectric layer 101 comprises three dielectric sub-layers. The circuit board as is shown in FIG. 1a is a four-layer board comprising two signal layers 103, 104 and two supply layers 121, 122.

In this embodiment, the first supply plane 121 is a reference plane for the first signal trace 107. Thus, a current return path for a signal propagating on the first signal trace 107 is provided by the reference plane 121. Moreover, the reference plane 121 provides a current return path for a signal propagating on the wire 111 through the through-hole 105. The current return path stays uninterrupted only in case of one Vdd/GND plane. In case of two Vdd/GND planes, as in the implementation shown in FIG. 1a, the current return path is cut, but a crosstalk with neighboring vias is reduced because of a shielding by the coaxial via structure. In this case it is possible to keep a perfect AC current return path by arranging a capacitor in between the lower part of the conducting cylinder 117 and the supply plane 122, which will require an additional via. Such a capacitor could be inserted once per group of vias. The second reference plane 122 is a reference plane for the second signal trace 109.

According to a further embodiment, the dielectric layer comprises only a single reference plane being connected to the coating of the through-hole. In such an embodiment, there is no break in the current return path of a signal propagating from the first signal trace via the wire to the second signal trace as the single reference plane is a reference plane for the first and second signal traces as well as for the wire.

According to a further embodiment, the coating of the via can be connected to a supply voltage trace on the first or the second surface of the dielectric layer.

FIG. 1b shows a three-dimensional view of the signal traces 107, 109 and the coaxial via comprising the coating 117, the isolating element 119 and the wire 111. For reasons of clarity the dielectric layers, power planes and ground planes are not shown in FIG. 1b. As can be seen from FIG. 1b, no annular plates are necessary to connect the signal traces 107, 109 to the via.

FIG. 1c shows an equivalent schematic of the coaxial vias shown in FIGS. 1a and 1b. A first impedance Z1 and a second impedance Z2 represent the first and second signal traces. The coaxial via formed from the wire 111, the coating 117 and the isolating element 119 is represented by the impedance Z3.

In the embodiment, the dimensions of the wire 111, the distance between the wire 111 and the coating 117 as well as the dielectric constant of the isolating element 119 are such that the impedance Z3 is 60 Ohm which is equal to the impedances Z1, Z2 of the signal traces.

Due to the absence of plates which connect the via to the signal traces 107, 109, there is no disturbing capacity in the equivalent schematic. Moreover, due to the wire 111 forming a coaxial cable together with the coating 117, there is no inductance in the equivalent schematic. This results in a continuous impedance along the signal path from the first signal trace 107 over the via to the second signal trace 109.

FIG. 2a shows a cross-sectional view of a wiring element comprising the wire 111 and the isolating element 119.

FIG. 2b shows a three-dimensional view of the wiring element as shown in FIG. 2a.

According to an embodiment, the wire 111 comprises a middle section which is surrounded by the isolating element 119 at two end sections which are not surrounded by the isolating element 119. In this embodiment, the isolating element 119 is formed by a dielectric tube or a cylinder made of dielectric material. The dielectric tube 119 has a length which corresponds to the thickness of the dielectric layer 101 or which is slightly higher than the dielectric layer 101 to prevent a contact between the central wire 111 and the conducting cylinder 119 and a width which corresponds to the inner width of the through-hole 105 shown in FIG. 1a. The wire 111 is arranged in the middle of the isolating tube 119.

According to a further embodiment, more than one wire is fit into such a via. The wires are then folded to different directions towards different traces.

In the following, a method for producing the circuit board with a coaxial cable via according to an embodiment of the present invention is described.

In a first step, a wire element as it is shown in FIGS. 2a and 2b is inserted into a drilled hole of the circuit board. The circuit board may comprise a plurality of signal layers, supply layers and dielectric sub-layers for isolating the signal and supply layers. Preferably, the via element is inserted into the drilled hole such that the isolating element fills out the whole drilled hole.

In a second step, the end sections of the wire element are folded or bent such that each end section gets in contact with signal traces on the surface of the dielectric layer. In order to fix the ends of the via to the signal traces, the via can be soldered to the signal traces. The step of folding the end sections of the wire and the step of soldering the end sections to the signal traces can be done in a common technological cycle together with the mounting or soldering of other components.

While this invention has been described in terms of several preferred embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents that fall within the true spirit and scope of the present invention.

### REFERENCE SIGN LIST

101 dielectric layer
103 first surface of the dielectric layer
104 second surface of the dielectric layer
105 through-hole
107 first signal trace
109 second signal trace
111 wire
113, 115 solder bumps
117 coating
119 isolating element
121 first supply layer
122 second supply layer
301 dielectric layer
305 through-hole
307 first signal trace
309 second signal trace
317 coating
317a first plate
317b second plate
321 third supply layer
322 second supply layer
Z1 impedance of the first signal trace
Z2 impedance of the second signal trace
Z3 impedance of the coaxial via
L inductance of the coating
C1, C2 capacity of the plates

What is claimed is:

1. A circuit board, comprising:
a dielectric layer;
a through-hole between a first and a second surface of the dielectric layer;
an electrically conductive coating arranged on a wall of the through-hole between the first and the second surface;
a first signal trace arranged on the first surface;
a second signal trace arranged on the second surface; and
a wire passing through the through-hole and connecting the first signal trace to the second signal trace, wherein the wire and the conductive coating form a coaxial line.

2. A circuit board according to claim 1, further comprising an electrically isolating element arranged between the coating and the wire.

3. A circuit board according to claim 2, further comprising:
a reference voltage plane being connected to the coating.

4. A circuit board according to claim 3, wherein the reference voltage plane is arranged between the first and second surfaces of the dielectric layer, such that the reference voltage plane and the coating provide a continuous return path for a signal propagating on the first single trace and the wire.

5. A circuit board according to claim 4, comprising a second reference voltage plane being arranged in parallel to the first reference voltage plane, such that the second voltage reference plane provides a current return path for a signal propagating on the second signal trace.

6. A circuit board according to claim 2, wherein the wire, the electrically isolating element and the electrically conductive coating are designed such that an impedance of a coaxial line formed by these elements is equal to an impedance of the first signal trace.

7. A method for producing a circuit board comprising the steps of:
providing a dielectric layer which comprises a through-hole between a first and a second surface of the dielectric layer and a first signal trace on the first surface and a second signal trace on the second surface;
arranging an electrically conductive coating on a wall of the through-hole between the first and the second surface;
arranging a wire within the through-hole such that a dielectric is arranged between the wire and the conductive coating; and
connecting the wire to the first signal trace and the second signal trace, wherein the wire and the conductive coating form a coaxial line.

8. The method according to claim 8, wherein the wire comprises a middle section being surrounded by a dielectric element and wherein the step of arranging is such that the dielectric element is arranged within the through-hole; and wherein the step of connecting comprises a step of bending end sections of the wire towards the first and the second signal traces.
